(19) United States
(12) Patent Application Publication
(10) Pub. No.: US 2015/0114347 A1
(43) Pub. Date: Apr. 30, 2015

(54) Throttle Position Sensor (TPS) Clocker

(71) Applicant: HOLLEY PERFORMANCE PRODUCTS INC., Bowling Green, KY (US)

(72) Inventors: Coy HUDNALL, Bowling Green, KY (US); Shane WECKERLY, Bowling Green, KY (US); Jim POUNDS, Auburn, KY (US)

(21) Appl. No.: 14/470,664

(22) Filed: Aug. 27, 2014

Related U.S. Application Data
(60) Provisional application No. 61/897,397, filed on Oct. 30, 2013.

(51) Int. Cl. F02D 41/00; F02D 9/10

(52) U.S. Cl. CPC F02D 41/0002; F02D 41/009; F02D 9/105
USPC 123/350

(57) ABSTRACT

The current invention includes throttle body devices with an air intake, a throttle plate in the air intake including a throttle plate shaft, wherein the throttle plate shaft horizontally traverses the throttle body, a throttle position sensor (“TPS”) attached to an end of the throttle plate shaft, and a rotational adjustment ring disposed between the throttle position sensor and the throttle body. The throttle position sensor is coupled to the rotational adjustment ring, and the rotational adjustment ring is rotatably adjustable to allow adjustment of the voltages sent from the TPS to an engine control until (“ECU”) at given positions.

### CROSS REFERENCE TO RELATED APPLICATIONS

The present application claims the benefit of priority of U.S. Provisional Application No. 61/897,397 filed Oct. 30, 2013, which is incorporated herein by reference.

### BACKGROUND OF THE INVENTION

Throttle bodies, when used with electronic fuel injection, typically utilize a sensor commonly called a throttle position sensor (“TPS”). This sensor interacts with the engine's electronic control unit (“ECU”) to communicate the position of the throttle plate and/or shaft. In some cases the rotational mounting of the TPS can be out of position relative to the throttle plate and/or shaft. This issue may be seen upon the initial installation of either the throttle body and/or the ECU. This mismatch can be caused by a number of circumstances including but not limited to manufacturing tolerances, high idle settings on aggressive race engines and/or large engine sizes.

Because of application variations, assemblies that utilize a TPS can send incorrect information to the engine ECU because of misalignments of the TPS. In the past it was common for end-users to modify the TPS by manually elongating the TPS mounting holes with a drill or mill so it could be repositioned so the ECU would receive the correct idle and open throttle voltages. However these methods can be inaccurate and may damage the TPS or throttle body.

The embodiments of this invention correct these deficiencies by providing a TPS clocker that allows rotational adjustment without the modification of the TPS or the housing to which the TPS is mounted.

### SUMMARY OF THE INVENTION

In view of the foregoing, it is a feature of the embodiments described herein to provide a throttle body assembly including an adjustment ring or other means for attaching the TPS to the throttle body, while allowing some rotational freedom and adjustment of the TPS relative to the throttle position, so the ECU receives the correct output voltages from the TPS.

### BRIEF DESCRIPTION OF THE DRAWINGS

A complete understanding of the embodiments of the present invention may be obtained by reference to the accompanying drawings, when considered in conjunction with the subsequent, detailed description, in which:

FIG. 1 is a top plan view of a throttle body including an embodiment of the invention.

FIG. 2 is a side plan view of a throttle body including an embodiment of the invention.

FIG. 3 is an isometric plan view of a throttle body including an embodiment of the invention.

FIG. 4 is an isometric plan view of a throttle body including an embodiment of the invention with the TPS removed for clarity.

FIG. 5A is a top plan view of an embodiment of the rotational adjustment ring.

FIG. 5B is and an isometric view of the embodiment of the rotational adjustment ring in FIG. 5A.

FIG. 6 is an isometric plan view of a throttle body including an alternative embodiment of the invention.

### DETAILED DESCRIPTION OF THE INVENTION

The following description is intended to convey a thorough understanding of the embodiments by providing a number of specific embodiments and details involving devices for adjusting rotational alignment of throttle position sensors on throttle bodies. It is understood, however, that the invention is not limited to these specific embodiments and details, which are exemplary only. It is further understood that one possessing ordinary skill in the art, in light of known devices, systems and methods, would appreciate the use of the invention for its intended purposes and benefits in any number of alternative embodiments.

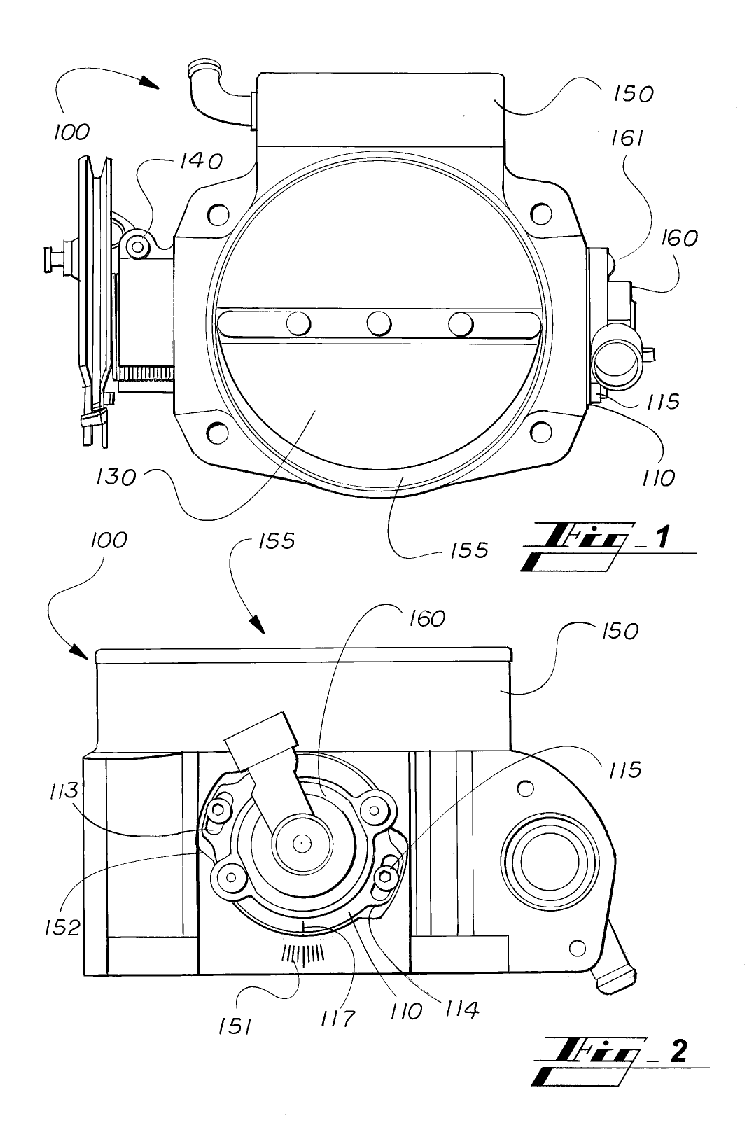

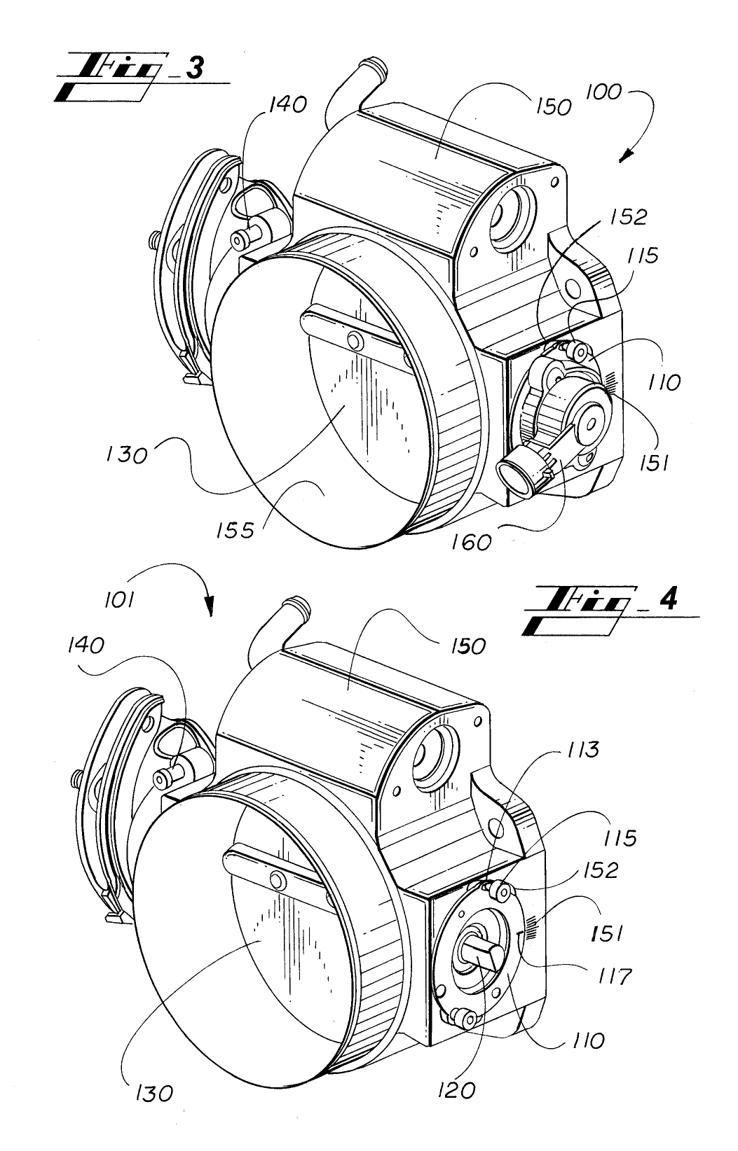

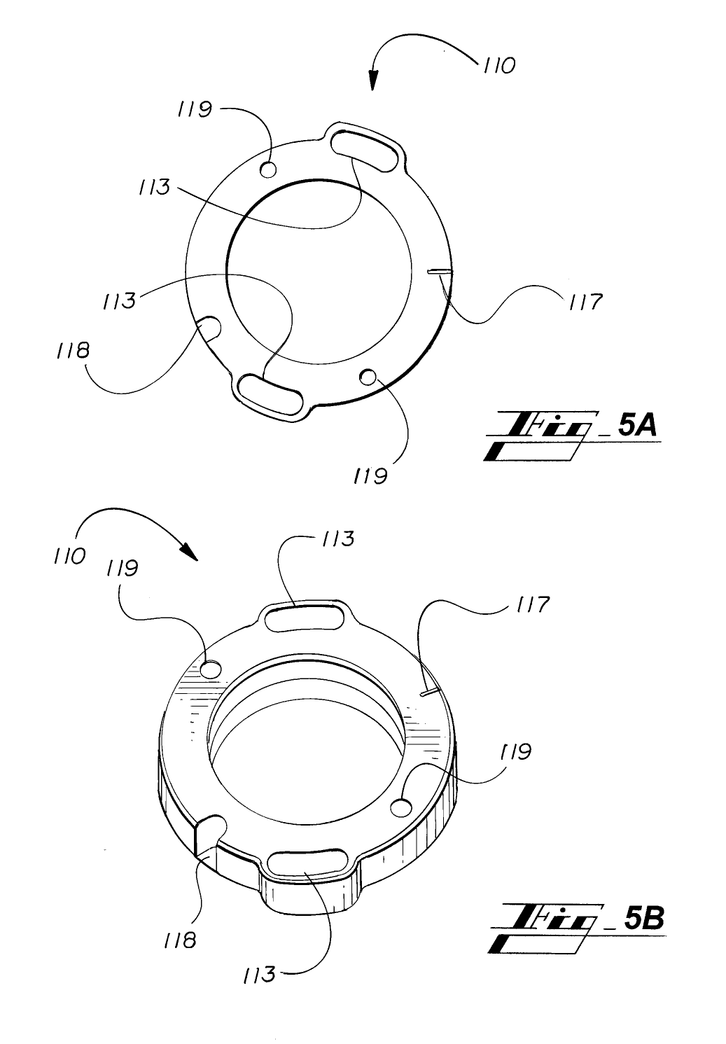

As shown in FIG. 1 and FIG. 2, a throttle body assembly 100 according to one embodiment of the invention may include a throttle body 150 with an air intake 155, a throttle plate 130 including a throttle plate shaft 120 (as shown in FIG. 4) traversing horizontally across the air intake port 155, a throttle plate idle adjustment screw 140 and a throttle position sensor (“TPS”) 160 coupled to an end of the throttle plate shaft 120. As the throttle plate idle adjustment screw 140 is adjusted to alter the engine idle RPM, the throttle plate shaft 120 rotates, which in turn rotates the throttle plate 130 and the rotor (not shown) in the TPS 160 which may change the TPS's output voltage sent to the ECU to an incorrect value.

In exemplary embodiments of the invention, the TPS 160 is connected to a rotational adjustment ring 110 by fasteners 161, with the throttle plate shaft 120 passing through a center opening of the adjustment ring 110. The rotational adjustment ring 110 may include one or more radial slots 113 which may be in complimentary tabs 114, allowing finite radial adjustment of the rotational angle of the TPS 160 in relation to the throttle body 150 and/or throttle plate shaft 120. The radial adjustment of the TPS 160 may be used to correct, or otherwise alter, the output voltage sent from the TPS 160 to the ECU. The rotational adjustment ring 110 may be coupled to the throttle body 150 by fasteners 115 (such as bolts, screws, pins, rivets, clips, etc.). Fasteners 115 may be loosened and/or removed to allow rotation of the rotational adjustment ring 110 and the attached TPS 160 to achieve a desired output voltage. When the desired output voltage is achieved fasteners 115 may be retightened and/or reinstalled to prevent further rotation of the rotational adjustment ring 110 and attached TPS 160.

In some embodiments, as shown in FIGS. 2-4, throttle body 150 may include a cavity 152 shaped to insert the rotational adjustment ring 110 while still allowing finite rotational adjustment of the rotational adjustment ring 110. Cavity 152 may be configured to limit adjustment of the rotational adjustment ring 110 and TPS 160 to prevent damage to the TPS 160 and other engine components by over rotation.

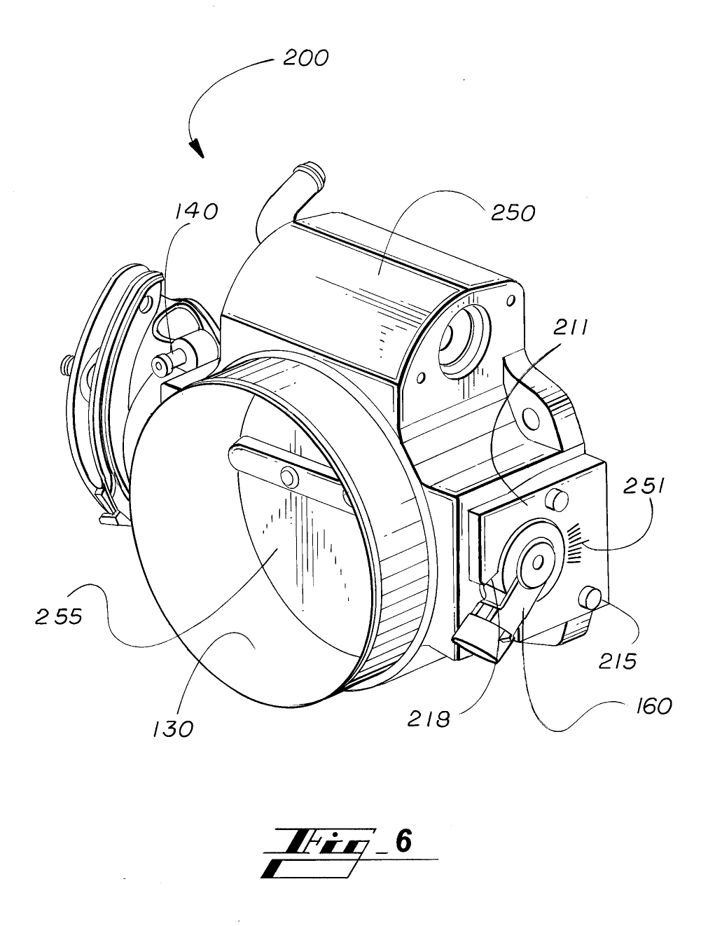

In some embodiments, the rotational adjustment ring 110 may include a TPS position reference mark 117, as shown in FIGS. 2, 4 and 5A-B.

In some embodiments, the throttle body 150 may include radial position reference marks 151 around the installation location of the TPS 160 , as shown in FIGS. 2-4. In preferred embodiments the throttle body 150 may include an odd number of evenly spaced radial position reference marks 151 with the center mark aligned with the vertical axis of the throttle body 150.

Preferred embodiments may further be arranged so the fasteners 115 are centered in radial slots 113 when the TPS position reference mark 117 is aligned with the center mark of the radial position reference marks 151.

Position reference marks 117 and 151 may be combinations of raised marks, indented marks, painted and other applied marks to improve visibility.

In some embodiments, a seal, such as an o-ring or gasket, may be installed between throttle body 150 and rotational adjustment ring 110 to seal, and otherwise prevent intrusion of liquids, moisture, dust, dirt and/or debris into the throttle body 150 and/or TPS 160.

As shown in FIG. 6, an alternative embodiment of the throttle body assembly 200 may include a throttle body 250 with a TPS 160 clamped to the throttle body 250 by a rotational adjustment plate 211 with fasteners 215. Rotational adjustment plate 211 may include an opening 218 configured to allow finite radial adjustment of the rotational angle of the TPS 160 in relation to the throttle body 250.

In some alternative embodiments, the rotational adjustment plate 211 may include radial position reference marks 251 around the installation location of the TPS 160, similar to those in other embodiments. In addition a reference , such as a painted dot or other marking (not shown), may be added to the a visible surface of the TPS 160 near the radial position reference marks 251 for reference during rotational adjustment.

In the preceding specification, various exemplary embodiments have been described with reference to the accompanying drawings. It will, however, be evident that various modifications and changes may be made thereto, and additional exemplary embodiments may be implemented, without departing from the broader scope of the invention as set forth in the claims that follow. The specification and drawings are accordingly to be regarded in an illustrative rather than a restrictive sense.

What we claim is:

1. A throttle body assembly comprising:
a throttle body;
an air intake port including a center axis disposed in the throttle body;
a cavity disposed in the throttle body, wherein the cavity is shaped to insert a rotational adjustment ring;
a throttle plate disposed in the air intake port including a throttle plate shaft, wherein the throttle plate shaft horizontally traverses the throttle body through the air intake port center axis and the cavity;
a rotational adjustment ring disposed in the cavity rotatably coupled to the throttle body; and
a throttle position sensor rotatably coupled to an end of the throttle plate shaft and fixedly coupled to the rotational adjustment ring.

2. The throttle body assembly of claim 1, wherein the rotational adjustment ring includes at least one radial slot; wherein a fastener at least partially disposed in the at least one radial slot couples the rotational adjustment ring to the throttle body.

3. The throttle body assembly of claim 1, wherein the rotational adjustment ring includes a throttle position sensor reference mark disposed on a surface visible to a user.

4. The throttle body assembly of claim 3, wherein the throttle body includes a plurality of radial position reference marks disposed radially near an outer edge of the cavity on a surface visible to a user.

5. The throttle body assembly of claim 4, wherein the plurality of radial position reference marks includes an odd number of radial position reference marks, and wherein a center mark of the odd number of radial position reference marks is starting alignment adjustment mark.

6. The throttle body assembly of claim 2, wherein said rotational adjustment ring further includes at least one tab, wherein at least a portion of the at least one radial slot is disposed in the at least one tab.

7. The throttle body assembly of claim 1:
wherein the rotational adjustment ring includes two tabs disposed 180 degrees apart from each other on a radial surface;
wherein a radial slot is at least partially disposed in each tab; and
wherein the cavity is shaped to allow finite rotation of the rotational adjustment ring.

8. The throttle body assembly of claim 1, wherein the throttle position sensor is fixedly coupled to the rotational adjustment ring by at least one fastener.

9. The throttle body assembly of claim 1, wherein the rotational adjustment ring includes an O-ring seal.
